(19) United States
(12) Patent Application Publication
(10) Pub. No.: US 2005/0030623 A1
(43) Pub. Date: Feb. 10, 2005

(54) Optical isolator and variable optical attenuator isolator using liquid crystals

(76) Inventor: Seungug Koh, Sunnyvale, CA (US)

Correspondence Address: Reveo, Inc., 85 Executive Blvd., Elmsford, NY, 10523, US

(21) Appl. No.: 10/878,636

(22) Filed: Jun. 28, 2004

Related U.S. Application Data
(60) Provisional application No. 60/482,944, filed on Jun. 27, 2003.

(51) Int. Cl. G02B 27/28

(52) U.S. Cl. 359/484; 349/193

(57) ABSTRACT

A combination optical element is disclosed wherein the functions of an optical isolator, a variable attenuator and an optical switch are combined into a component optical device. The optical element provides robust optical signal generation and detection and can compensate for polarization dependent losses of other optical devices. The proper combination of devices to form the combination optical element is disclosed so that proper propagation of optical signals in the forward and backward direction is preserved.

### TECHNICAL FIELD

The present invention relates to electrooptical devices, and more particularly to optical isolators and variable optical attenuator isolators.

### BACKGROUND OF THE INVENTION

Optical components such as optical switches, optical isolators, optical circulators, lasers, optical detectors and variable optical attenuators, are conventionally discretely fabricated and separately packaged.

An optical isolator conventionally includes two collimating elements, typically lenses at the input and output ports of the device and a core assembly located between the collimating elements. A variable optical attenuator (“VOA”) is an optical device with which the amplitude or power level of an input optical signal may be attenuated by a variable amount to provide an output optical signal of a desired amplitude or power level. The power levels of the various wavelength channels on an optical fiber may be substantially equalized in a “load balancing” or “load equalization” process in which each wavelength channel is routed through a separate variable optical attenuator.

In order to devise a composite optical element combining an optical isolator with variable attenuation, J. Kim of Samsung Electronics Co. has disclosed an optical attenuating isolator in U.S. Pat. No. 6,297,901 by combining optical isolator and a group of mechanically moving optical neutral filters. This isolator is based on mechanical actuation of attenuating filter set with a fixed step in attenuation amounts. Significantly, it cannot correct the polarization dependent losses of other optical devices and the mechanical operation of such device presents many difficulties in terms of speed, reliability, size, and cost.

Wu et al. of Chorum Technologies Inc. has disclosed a liquid crystal-based VOA in U.S. Pat. No. 5,963,291 by combining birefringent elements and liquid crystal cells. However, such a VOA does not support an optical isolation functionality.

Accordingly, a need remains in the art for a composite optical element which is reliable, fast, compact and lower cost and combines the functions of optical switch-isolators and VOA-isolators.

### BRIEF SUMMARY OF THE INVENTION

The above-discussed and other problems and deficiencies of the prior art are overcome or alleviated by the several apparatus and methods of the present invention for optical switch-isolaters and VOA-isolators. In one aspect, the invention is a composite optical component comprising: a liquid crystal cell and an isolator, wherein the state of polarization of light passing through the liquid crystal cell is maintained such that optical signals along subsequent optical paths propagate without interrupting the operation of said isolator.

In another aspect, the invention is an optical component comprising: a first birefringent element; a switchable liquid crystal element optically coupled to said first birefringent element; a polarization beam splitter optically coupled to said switchable liquid crystal element; a Faraday rotator optically coupled to said polarization beam splitter; a waveplate optically coupled to said Faraday rotator; a linear polarizer optically coupled to said waveplate; a variable liquid crystal element optically coupled to said linear polarizer; and a second birefringent element optically coupled to said variable liquid crystal element.

In another aspect, the invention is an optical component comprising: a variable optical attenuator and an isolator, wherein the variable optical attenuator comprises a liquid crystal cell.

The above-discussed and other features and advantages of the present invention will be appreciated and understood by those skilled in the art from the following detailed description and drawings.

### BRIEF DESCRIPTION OF THE FIGURES

The foregoing summary as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings wherein:

FIG. 1 is a schematic diagram of a combination of isolator and VOA combination with light flow in the forward direction;

FIG. 2 is a schematic diagram of a combination of isolator and VOA combination with light flow in the backward direction;

FIG. 3 is a schematic diagram of an optical switch and isolator in combination illustrating light flow in the forward direction;

FIG. 4 is a schematic diagram of an optical switch and isolator in combination illustrating light flow in the backward direction;

FIG. 5 is a schematic diagram of an optical switch isolator in combination with a VOA illustrating light flow in the forward direction for an incorrect combination of optical elements;

FIG. 6 is a schematic diagram of an optical switch isolator in combination with a VOA illustrating light flow in the backward direction for an incorrect combination of optical elements;

FIG. 7 is a schematic diagram of an optical switch isolator in combination with a VOA illustrating light flow in the forward direction; and

FIG. 8 is a schematic diagram of an optical switch isolator in combination with a VOA illustrating light flow in the backward direction.

### DETAILED DESCRIPTION OF THE FIGURES

Herein disclosed is a composite macro-optic devices which combines the functions of an optical switch-isolator and variable optical attenuator (VOA)-isolators.

Liquid crystal cells are polarization dependent and they normally alter the state of polarization (“SOP”) of passing-through optical signals to make it difficult to integrate with other optical devices. In order to combine optical isolator and VOA, it is desirable to maintain the SOP of optical signals in VOA stages such that optical signals along the subsequent optical paths can propagate properly without interrupting the isolator operation.

The disclosed invention utilizes a non-mechanical actuation by using liquid crystal materials to allow a fast, reliable, accurate, and low-cost operation. By using dual and orthogonal optical paths along liquid crystal cells, it is also possible to correct and compensate the polarization dependent losses of other optical devices. The disclosed invention can also monitor the incoming optical signals and it can be combined with other optical elements such as optical switches and optical circulators.

The present invention allows the integration of optical isolator, variable optical attenuator, optical switch, optical circulator, polarization dependent loss (“PDL”) compensator, or any combination thereof into a single package by using liquid crystal elements, waveplate, linear polarizers, birefringence elements, polarization beam splitters, comer mirrors, and fibers with collimating lenses.

The combination of Faraday rotator and waveplate placed between input and output birefringence elements allows the optical signals to propagate in a forward direction only in all of the detailed embodiments of the present invention. The combination of switchable liquid crystal element and polarization beam splitter provides a beam steering functionality to be used in optical switching. The combination of linear polarizer and variable liquid crystal element positioned between waveplate and birefringence element can also provide a variable optical attenuation. In the following, the operation of these devices in combinations-with liquid crystal elements will be described in detail.

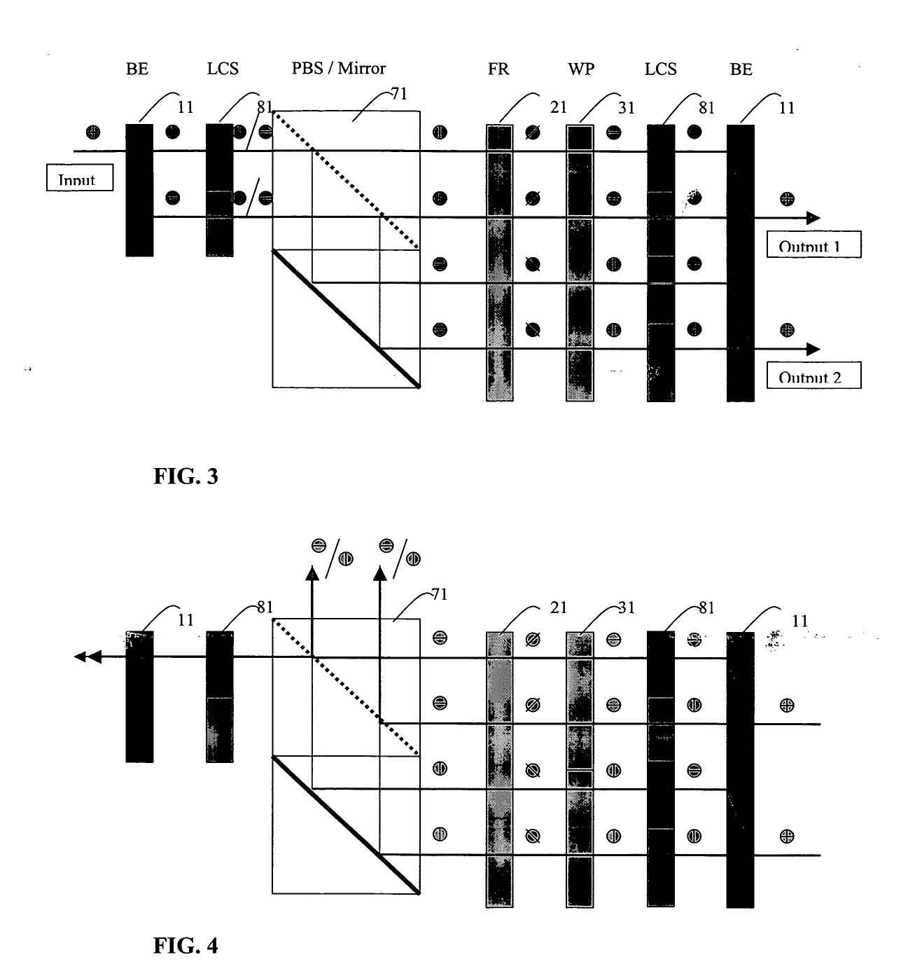

When a linearly polarized optical signal passes through a liquid crystal element, the state of polarization for the input signals can be changed into linearly polarized, circularly polarized, or elliptically polarized states depending on the amount of birefringence across the liquid crystal cell. Generally speaking, the output optical signals from the liquid crystal elements become elliptically polarized, unless a specifically controlled amount of birefringence for linear or circular polarization states are met by passing through the liquid crystal elements. It is understood that the switchable liquid crystal elements generate linearly polarized output signals, while the variable liquid crystal elements can generate elliptically polarized output signals. It is known that the elliptical state of polarization from the liquid crystal elements has prevented the integration of optical isolators with optical switches or VOA as shown in FIG. 3. The present invention provides unique and innovative device configurations to allow the integration of such devices.

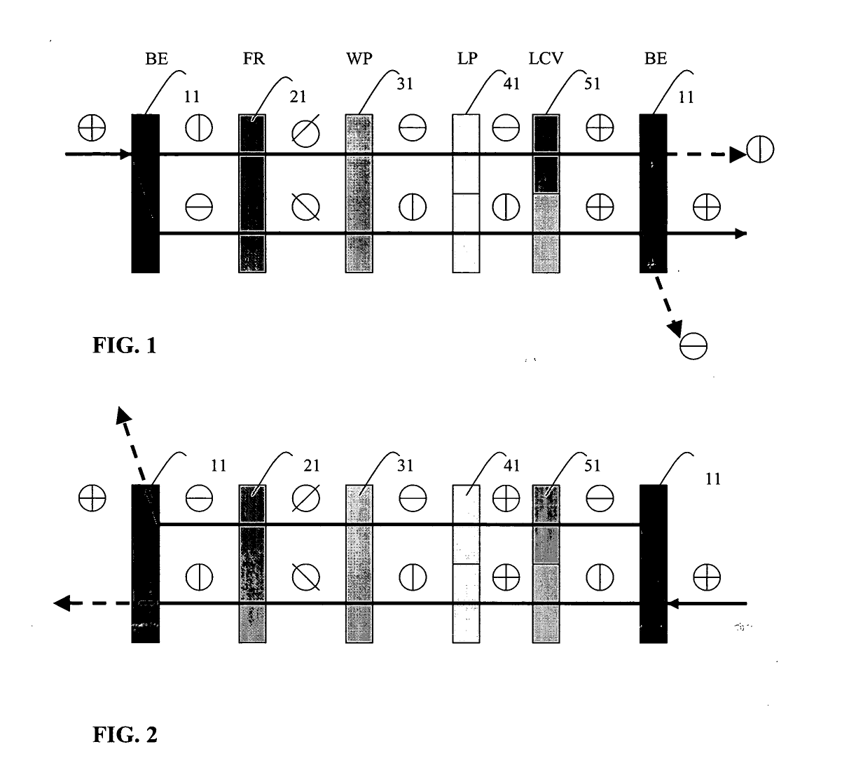

Referring to FIG. 1, for illustrative purposes a VOA and isolator configuration is constructed by combining a polarization insensitive optical isolator and VOA element. The polarization insensitive optical isolator is composed of input birefringence element 11, a Faraday rotator 21, a waveplate 31 and an output birefringence element 11. The VOA component of the present invention is composed of a linear polarizer 41 and variable liquid crystal element 51. The VOA component is interposed between the output birefringent element 11 and the waveplate 31. A birefringent element 11 is coupled at the output ports. Without the VOA component, the device structure of FIG. 1 becomes a polarization insensitive optical isolator. Therefore, the VOA component, the linear polarizer 41 and variable liquid crystal element 51 combination, can charge the state of polarization for incoming optical signals to an elliptical one by varying the amount of bias voltage across the liquid crystal cell. The output birefringence element 11 subsequently can combine only a part of incoming optical signals with a suitable state of polarization for the polarization beam combiner.

The selective recombination of optical beams can provide a variable amount of optical attenuation. For instance, referring now to FIG. 2, optical signals propagating in a backward direction, the linear polarizer 41 in front of variable liquid crystal element 51 decouples the unwanted part of optical signals in the backward direction. During this process, the linear polarizer 41 transforms the elliptically polarized optical signals into a linearly polarized state. The subsequent isolator elements (i.e. Faraday rotator and waveplate) align the state of polarization such that the input birefringence element cannot combine any of the backward propagating optical signals. It will be understood that in the VOA in combination with an optical isolator configuration, a plurality of linear polarizers 41 and variable liquid crystal elements 51 can be serially cascaded in combination in order to increase the dynamic range of VOA.

It will be noted that the independent optical paths for two linearly polarized optical signals in FIGS. 1 and 2 can be used for polarization dependent loss control. By utilizing an independent linear polarizer and variable liquid crystal element combination for two optical paths, it is possible to introduce a variable amount of attenuation per polarization state such that polarization dependent losses from other optical devices can be compensated in order to stabilize the optical signal.

Referring now to FIG. 3, there is shown an optical switch and isolator configuration in an optical switch and isolator combination configuration. Here, the optical switch includes a input birefringence element 11, switchable liquid crystal element (“LCS”) 81, polarization beam splitter (“PBS”) in combination with a corner mirror 71, a Faraday rotator 21, a second LCS 81 and output birefringence element 11. The LCS 81 rotates the state of polarization of incoming optical signals to enable a polarization independent optical switching. The insertion of an optical isolator element (composed of a Faraday rotator 21 in combination with a waveplate 31) allows unidirectional optical signal propagation. Referring to FIG. 4, there is illustrated the optical signal propagation in the backward direction.

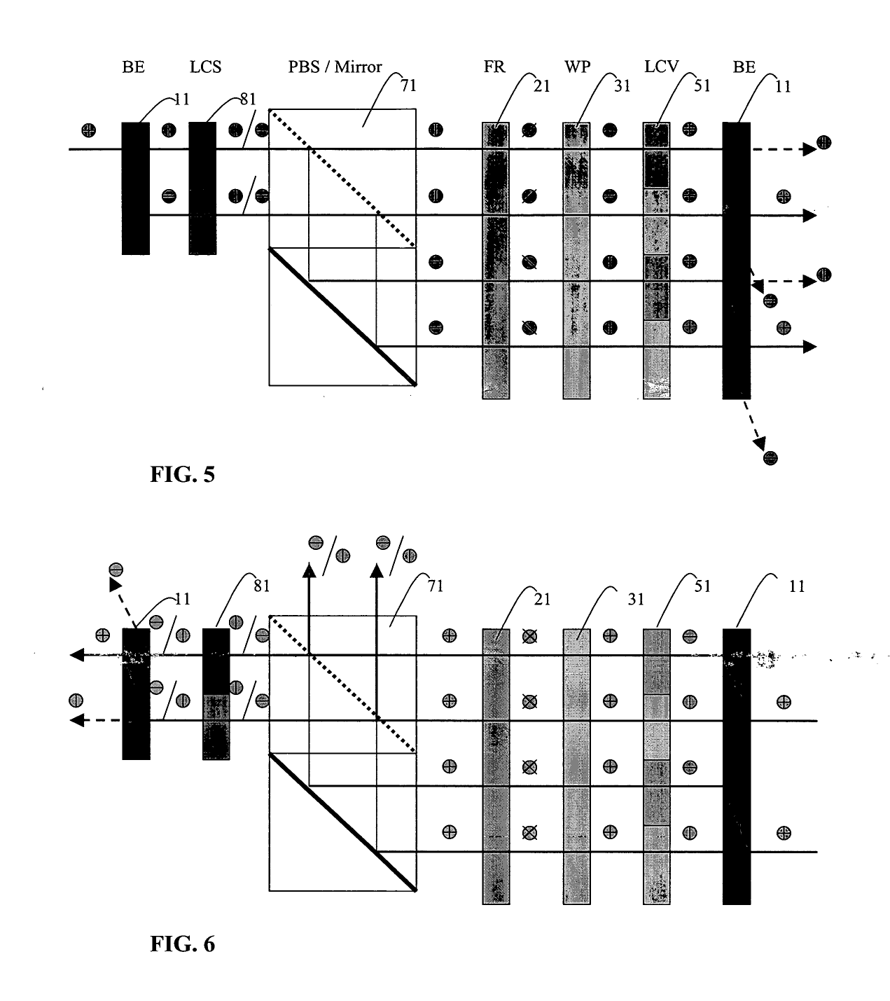

It will be understood that an incorrect combination of the aforementioned optical components would result in an improper version of a component VOA, isolator and optical switch configuration. Such an improper version of combination are illustrated in FIGS. 5 and 6. The LCS 81 of FIGS. 3 and 4 are replaced by the variable liquid crystal element (“LCV”) 51 in front of the birefringent element 11. It is attempting to replace the LCS in front of output birefringence element with a variable liquid crystal element to add a VOA functionality on top of the existing optical switch and isolator configuration. However, the elliptical state of polarization out of LCV invalidates the optical isolator as shown in FIG. 5 where the forward direction flow of the optical signal is illustrated. Referring now to FIG. 6, there is shown the optical signal propagation in the backward direction.

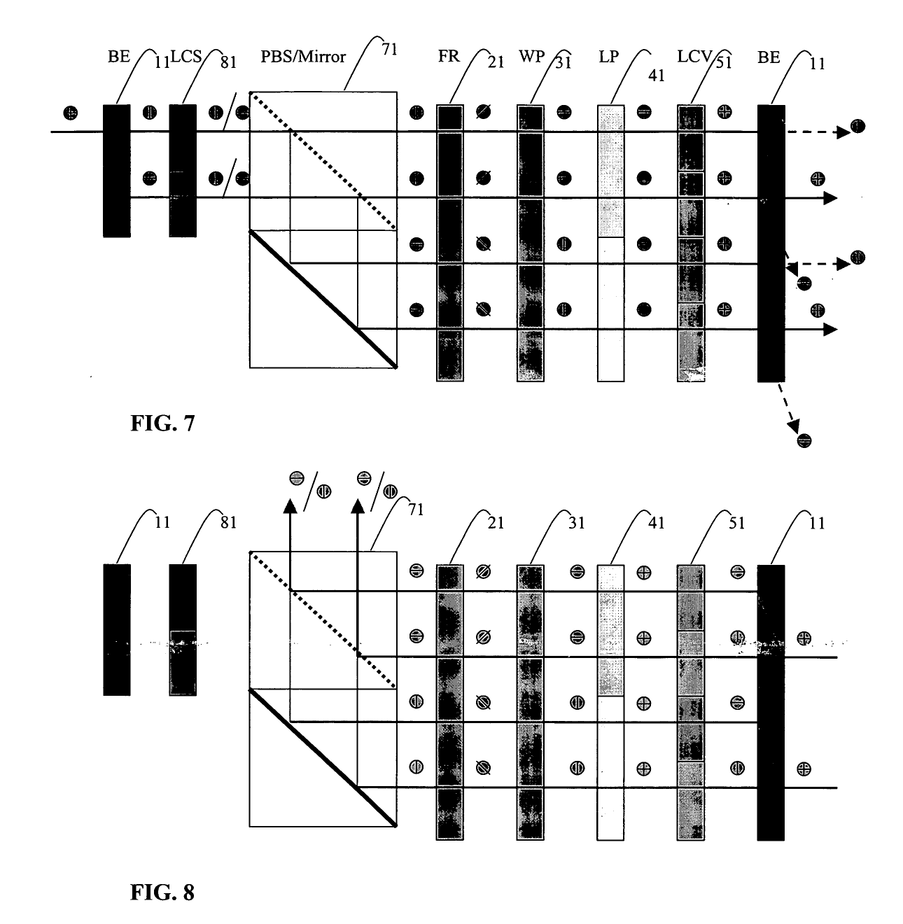

To overcome the above illustrated problem, a correct version of a VOA in combination with an isolator and an optical switch configuration is illustrated in FIGS. 7 and 8. Significantly, the addition of a linear polarizer 41 interposed between the waveplate 31 and the LCV 51 guarantees a proper operation of optical switch, VOA, and optical isolator.

For optimal performance of the devices described herein, the following principles and preferred configurations for the LCV 51 are provided.

Nematic Liquid Crystal Retarder:

In one embodiment, placing a liquid crystal retarder in between two parallel linear polarizers. Assuming linear polarizers are placed with their transmission axis pointing in the x-axis. The Jones matrixes of these optical components are

$$\begin{matrix}{T}_{LP1} = [ \begin{matrix}1 & 0 \\ 0 & 0\end{matrix} ] , & {T}_{LP2} = [ \begin{matrix}1 & 0 \\ 0 & 0\end{matrix} ] , & {T}_{LC} = [ \begin{matrix}1 & 0 \\ 0 & exp ( - j ϕ )\end{matrix} ]\end{matrix} \qquad ( 1 )$$

To achieve the attenuation effect, we rotate the LC retarder by angle θ around the z-axis so that the optical axis of the LC retarder makes angle θ with the x-axis, and the LC cell is the x-y plane.

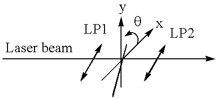

The Jones matrix of the above system is

$${T}_{total} = {T}_{LP2} R ( θ ) {T}_{LC} R ( - θ ) {T}_{LP1} , R ( θ ) = [ \begin{matrix}cos ( θ ) & sin ( θ ) \\ - sin ( θ ) & cos ( θ )\end{matrix} ] is the rotation matrix .$$

One can show that varying the phase retardation of the liquid crystal cell can control the transmission of laser beam. It can be shown that the transmission depends on the liquid crystal cell retardation as Iₒᵤₜ/Iᵢₙ=cos⁴ θ+sin⁴ θ+2 cos² θ sin² θ cos φ. If θ is set to π/4, then we obtain Iₒᵤₜ/Iᵢₙ=(1+cos φ)/2.

At off state, the retardation of the liquid crystal can be set at 2π. When the phase retardation is reduced to π, maximum attenuation is obtained.

Surface Stabilized Ferroelectric Liquid Crystal Cell:

In another embodiment, for a surface stabilized ferroelectric liquid crystal retarder, the applied voltage rotates the optical axis when have minimum impact on the phase retardation of the cell. The previous description regarding the Nematics Liquid Crystal retarder can be applied here as well. Iₒᵤₜ/Iᵢₙ=cos⁴θ+sin⁴ θ+2 cos² θ sin² θ cos φ. Set the birefringence of the SSFLC cell to π, we obtain Iₒᵤₜ/Iᵢₙ=cos⁴ θ+sin⁴ θ−2 cos^{2 θ sin}² θ. It is clear that dynamical range of the optical axis of the SSFLC cell needs to be from 0 to π/4 ensure maximum attenuation range.

Twisted Nematics Liquid Crystal Cell:

In yet another embodiment, assuming πΔnd>>φλ, where Δn is the birefringence of the liquid crystal material, d is the thickness of the LC cell, φ is the twist angle and λ is the wavelength of incident light, the linearly polarized light, with it polarization direction parallel to the rubbing direction, will rotate its plane of polarization following the twisted liquid crystal structure. If the twist angle φ is π/2, the exiting linear polarized light will be blocked by the second polarizer.

| | |
|---|---|
| 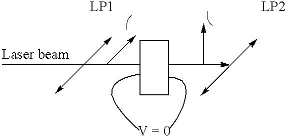 | When there is no voltage applied to the twist LC cell, light is blocked at LP2 |
| 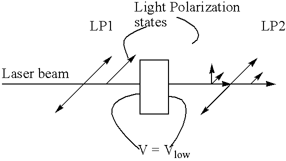 | When voltage is applied to the twist LC cell, light after the LC cell with polarization component parallel to LP2 will go through LP2 |
| 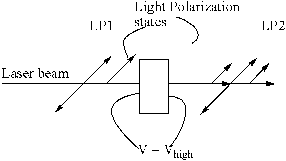 | When voltage is applied to the twist LC cell, light after the LC cell with polarization component parallel to LP2 will go through LP2 |

When the applied voltage is sufficiently high (3-5V), the twisted LC structure will be unwound, the effective birefringence of the LC cell is reduced to zero, maximum light transmission is obtained.

The person skilled in the art will appreciate that many of the systems herein disclosed are interchangeable. For instance, additional known means of securing the reflective coating may be employed in the containment enclosure of the present invention.

While preferred embodiments have been shown and described, various modifications and substitutions may be made thereto without departing from the spirit and scope of the invention. Accordingly, it is to be understood that the present invention has been described by way of illustrations and not limitation.

1. A composite optical component comprising:
a liquid crystal cell and an isolator, wherein the state of polarization of light passing through the liquid crystal cell is maintained such that optical signals along subsequent optical paths propagate without interrupting the operation of said isolator.

2. The optical component as in claim 1,
wherein dual and orthogonal optical paths along the liquid crystal cell correct and compensate polarization dependent losses.

3. The optical component as in claim 1, further comprising
at least one optical switch.

4. The optical component as in claim 1, further comprising
at least one optical circulator.

5. The optical component as in claim 1,
wherein the liquid crystal cell comprises a variable optical attenuator.

6. The optical component as in claim 1,
wherein the liquid crystal cell comprises an optical switch.

7. The optical component as in claim 1, further comprising
at least one polarization dependent loss compensator.

8. An optical component comprising:
a first birefringent element;
a switchable liquid crystal element optically coupled to said first birefringent element;
a polarization beam splitter optically coupled to said switchable liquid crystal element;
a Faraday rotator optically coupled to said polarization beam splitter;
a waveplate optically coupled to said Faraday rotator;
a linear polarizer optically coupled to said waveplate;
a variable liquid crystal element optically coupled to said linear polarizer; and
a second birefringent element optically coupled to said variable liquid crystal element.

9. The optical component of claim 8,
wherein said variable liquid crystal element is a nematic liquid crystal retarder.

10. The optical component of claim 8,
wherein said variable liquid crystal element is a surface stabilized ferroelectric liquid crystal cell.

11. The optical component of claim 8,
wherein said variable liquid crystal element is a twisted nematic liquid crystal cell.

12. An optical component comprising:
a variable optical attenuator and an isolator, wherein the variable optical attenuator comprises a liquid crystal cell.

13. The optical component as in claim 12, wherein the isolator is a polarization insensitive optical isolator comprising a input birefringence element as a polarization beam splitter, a Faraday rotator, a waveplate, and an output birefringence element as a polarization beam combiner, and further wherein the variable optical attenuator comprises a linear polarizer and a variable liquid crystal element.
